(19) United States
(12) Patent Application Publication
(10) Pub. No.: US 2023/0274848 A1
(43) Pub. Date: Aug. 31, 2023

(54) REACTOR OPERATION OPTIMIZATION METHOD BASED ON IMPROVED MULTI-POPULATION GENETIC ALGORITHM

(71) Applicant: Harbin Engineering University, Harbin (CN)

(72) Inventors: Genglei XIA, Harbin (CN); Minjun PENG, Harbin (CN); Shouyu CHENG, Harbin (CN); Qiang ZHAO, Harbin (CN); Xue DU, Harbin (CN); Hang WANG, Harbin (CN); Yuandong ZHANG, Harbin (CN); Chenyang WANG, Harbin (CN)

(73) Assignee: Harbin Engineering University, Harbin (CN)

(21) Appl. No.: 17/825,949

(22) Filed: May 26, 2022

(30) Foreign Application Priority Data
Feb. 28, 2022 (CN) 202210186363.3

(51) Int. Cl. G21C 7/36

(52) U.S. Cl. CPC G21C 7/36

(57) ABSTRACT

Disclosed is a reactor operation optimization method based on an improved multi-population genetic algorithm. The reactor operation optimization method includes the following steps: defining an operating condition, and designing an operating scheme according to the operating condition; obtaining operating data of the reactor system of the operating scheme through numerical simulation research, and obtaining operation indexes by calculating the operating data; optimizing the operation indexes based on an improved multi-population genetic algorithm to obtain an optimization result; obtaining an optimal operating parameter setting under the operating condition according to the optimization result. The application solves the problem that the design scheme of reactor operation control hardly meets actual operation requirements, and therefore improves operation characteristics of the reactor system.

### CROSS-REFERENCE TO RELATED APPLICATIONS

This application claims priority to Chinese Patent Application No. 202210186363.3, filed on Feb. 28, 2022, the contents of which are hereby incorporated by reference.

### TECHNICAL FIELD

The application belongs to the field of reactor operation control, and in particular to a reactor operation optimization method based on an improved multi-population genetic algorithm.

### BACKGROUND

The reactor operation control scheme plays an important role in ensuring safe, economical and stable operation of nuclear power plants. When a reaction operation control scheme is prepared, control strategies and parameters need to be simulated and debugged for many times in the design process, and then used for system operation after meeting the control requirements. In fact, the design scheme is generally conservative in actual operation of the reactor. Especially for the nuclear reactor device put into use in the early stage, although the design scheme can still perform the control task, the design scheme is not the best operation control scheme of the system. As experience in nuclear reactor operation and the progress in nuclear energy technology is continuously accumulated, it is necessary to continuously optimize and improve the operation control scheme of the reactor and improve the operation characteristics of the reactor system to meet actual operation requirements.

With the rapid development of optimization technology, meta-heuristics algorithms such as genetic algorithm, immune algorithm and particle swarm optimization algorithm are also applied to the design of control system, but they are still innovative measures in the field of reactor operation. Compared with other artificial intelligence algorithms, genetic algorithm has wider applicability and better searching ability, but has some problems such as premature convergence. Multi-population genetic algorithms are derived from genetic algorithm and improved. However, in actual iteration, when the iterative population is close to the optimal solution, individuals in the population can't continuously evolve to the optimal solution but oscillate around the optimal solution because the fitness difference of each individual in the population decreases.

### SUMMARY

In order to solve the technical problem that the design scheme is difficult to meet the actual operation requirements and the system operation characteristics are poor, the application aims to provide a reactor operation optimization method based on an improved multi-population genetic algorithm. Using the improved multi-population genetic algorithm to optimize the set values of operation control parameters can improve the weak links of the design scheme facing the actual operation requirements and improve the operation characteristics of the reactor system.

To achieve the above objective, the present application provides the following scheme: a reactor operation optimization method based on an improved multi-population genetic algorithm, including:

S1: defining an operating condition, and then designing an operating scheme according to the operating condition;

S2: obtaining operating data of the reactor system of the operating scheme through numerical simulation research, and obtaining operation indexes by calculating the operating data;

S3: optimizing the operation indexes based on an improved multi-population genetic algorithm to obtain an optimization result; obtaining an optimal operating parameter setting under the operating condition according to the optimization result.

Preferably, the operation indexes at least include an operation safety index and a thermal economic index;

the operation safety index is obtained by calculating a supercooling degree of a coolant reactor core outlet and a minimum deviation nucleate boiling value;

the thermal economic index is obtained by calculating a superheat degree of a steam outlet.

Preferably, the operation indexes include dynamic response indexes;

the dynamic response indexes at least include a stationarity index, a rapidity index and a steady-state performance index;

the stationarity index is obtained by calculating an overshoot;

the rapidity index is obtained by calculating an adjustment duration;

the steady-state performance index is obtained by calculating a steady-state error.

Preferably, before optimizing the operation indexes based on the improved multi-population genetic algorithm, the method further includes: determining the operation indexes to be optimized according to the actual demand; determining optimization variables and feasible regions, and carrying out the optimization calculation of the operation indexes to be optimized by using the improved multi-population genetic algorithm.

Preferably, the optimization variables are constant operating parameters required by a control strategy in the operating scheme;

the feasible regions are determined using a sensitivity analysis method of a single variable.

Preferably, the process of carrying out the optimization calculation of the operation indexes to be optimized by using the improved multi-population genetic algorithm includes,

providing operating parameters, wherein the multi-population genetic algorithm creates discrete random populations according to the parameter settings of the operating parameters, calculates the objective function value of the initial population after chromosome coding, and performs evolutionary operations on the initial population; a migration operator introduces a best individual into other populations every definite evolutionary algebra to replace a worst individual in a target population and realize the information exchange of the target population, and ends the calculation when a genetic algebra reaches a maximum value.

Preferably, the operating parameters at least include a population number, individual number, variable dimensions, generation gap value and maximum genetic algebra.

Preferably, the evolutionary operations on the initial population at least include a selection operation, a crossover operation and a mutation operation;

the crossover operation and mutation operation are based on adaptive strategies, and the crossover operator and mutation operator change from fixed values to changes with the fitness of the population.

Preferably, obtaining the optimal operating parameter setting under the operating condition includes comparing the operation result of the optimized scheme with the operation result of the designed operating scheme, and if the requirements are not met, returning to adjust the feasible region and recalculating; if the requirements are met, obtaining the optimal operating parameter setting under the operating condition based on the operation result of the optimization scheme.

The application discloses the following technical effects:

The reactor operation optimization method based on the improved multi-population genetic algorithm provided by the application can be applied to various reactor control systems, different operation control strategies and different operating conditions under variable working conditions, has strong universality and is easy to realize, and therefore has a broad application prospect. According to any variable load condition and operation control strategy, the optimal parameter setting in this condition can be obtained through optimization calculation, which can improve the weak link of the design scheme facing the actual operation requirements and improve the operation characteristics of the reactor system. By introducing the adaptive strategy, the operator can be adjusted according to the population fitness in the crossover and mutation operations of the algorithm, which further balances the global search and local search capabilities of the multi-population genetic algorithm, and solves the problem that the original algorithm tends to oscillate around the optimal value when used to optimize the operating characteristics of the reactor system.

### BRIEF DESCRIPTION OF THE FIGURES

In order to more clearly explain the embodiments of the present application or the technical solutions in the prior art, the following will briefly introduce the drawings that need to be used in the embodiments. Obviously, the drawings in the following description are only some embodiments of the present application. For those of ordinary skill in the art, other drawings may be obtained according to these drawings without any creative effort.

FIG. 1 is a method flow chart of an embodiment of the present application.

FIG. 2 is a schematic diagram of an optimization process based on an improved multi-population genetic algorithm according to an embodiment of the present application.

FIG. 3 is an optimization result diagram of the characteristic of reactor rapid load reduction according to the embodiment of the present application.

FIG. 4 is a characteristic diagram of reactor rapid load reduction operation under the optimized scheme of the embodiment of the present application.

FIG. 5 is a characteristic diagram of reactor rapid load reduction operation under the optimized scheme of the embodiment of the present application.

FIG. 6 is a flow chart of a reactor operation optimization method based on an improved multi-population genetic algorithm according to one embodiment of the present application.

FIG. 7 is a flow chart of a reactor operation optimization method based on an improved multi-population genetic algorithm according to another embodiment of the present application.

FIG. 8 is a flow chart of a reactor operation optimization method based on an improved multi-population genetic algorithm according to another embodiment of the present application.

### DETAILED DESCRIPTION OF THE EMBODIMENTS

The technical solutions in the embodiments of the present application will be clearly and completely described below with reference to the drawings in the embodiments of the present application. Obviously, the described embodiments are only part of the embodiments of the present application, but not all of them. Based on the embodiment of the present application, all other embodiments obtained by ordinary technicians in the field without creative labor are within the scope of the present application.

In order to make the above objectives, characteristics and advantages of the present application more obvious and understandable, the present application will be explained in further detail below with reference to the drawings and detailed description.

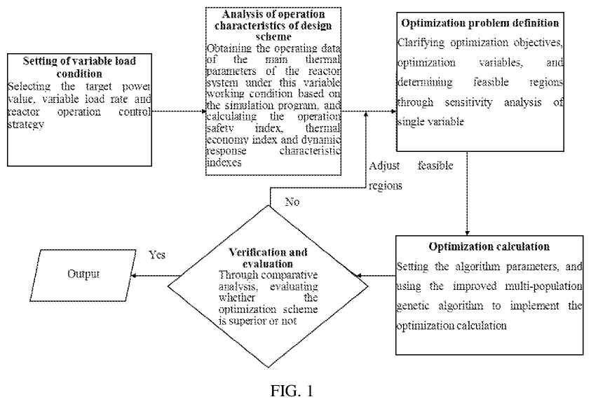

As shown in FIG. 1, the present application provides a reactor operation optimization method based on an improved multi-population genetic algorithm, which includes:

S1: defining an operating condition, and designing an operating scheme according to the operating condition;

S2: obtaining operating data of the reactor system of the operating scheme through numerical simulation research, and obtaining operation indexes by calculating the operating data;

S3: optimizing the operation indexes based on an improved multi-population genetic algorithm to obtain an optimization result; obtaining an optimal operating parameter setting under the operating condition according to the optimization result.

The operation indexes at least include an operation safety index and a thermal economic index;

the operation safety index is obtained by calculating a supercooling degree of a coolant reactor core outlet and a minimum deviation nucleate boiling value.

the thermal economic index is obtained by calculating a superheat degree of a steam outlet.

The operation indexes include dynamic response indexes;

the dynamic response indexes at least include a stationarity index, a rapidity index and a steady-state performance index;

the stationarity index is obtained by calculating an overshoot;

the rapidity index is obtained by calculating an adjustment duration;

the steady-state performance index is obtained by calculating a steady-state error.

Before optimizing the operation indexes based on the improved multi-population genetic algorithm, the method further includes: determining the operation indexes to be optimized according to the actual demand; determining optimization variables and feasible regions, and carrying out the optimization calculation of the operation indexes to be optimized by using the improved multi-population genetic algorithm.

The optimization variables are constant operating parameters required by a control strategy in the operating scheme;

the feasible regions are determined by a sensitivity analysis method of a single variable.

The process of carrying out the optimization calculation of the operation indexes to be optimized by using the improved multi-population genetic algorithm includes,

providing the operating parameters, wherein the multi-population genetic algorithm creates discrete random population according to the parameter settings of the operating parameters, calculates the objective function value of the initial population after chromosome coding, and performs evolutionary operations on the initial population; a migration operator introduces a best individual into other populations every definite evolutionary algebra to replace a worst individual in a target population and realize the information exchange of the target population, and ends the calculation when the genetic algebra reaches a maximum value.

The operating parameters at least include a population number, an individual number, variable dimensions, a generation gap value and maximum genetic algebra.

The evolutionary operations on the initial population at least include a selection operation, a crossover operation and a mutation operation;

the crossover operation and mutation operation are based on adaptive strategies, and the crossover operator and mutation operator change from fixed values to changes with the fitness of the population.

Obtaining the optimal operating parameter setting under the operating condition includes comparing the operation result of the optimized scheme with the operation result of the designed operating scheme, and if the requirements are not met, returning to adjust the feasible region and recalculating; if the requirements are met, obtaining the optimal operating parameter setting under the operating condition based on the operation result of the optimization scheme.

### Embodiment 1

As shown in FIG. 1, the reactor operation optimization method based on an improved multi-population genetic algorithm provided by the application includes the following steps:

S101: selecting a reactor operation control strategy and giving an initial value of operating parameters as a design scheme; defining the variable load condition, and selecting the target power value and variable load rate.

S102: obtaining the operating data of the main thermal parameters of the reactor system under this variable working condition based on the simulation program, and calculating the operation safety index, thermal economic index and dynamic response characteristic indexes. The calculating methods and related formulas are as follows:

(1) Operation Safety Index
i. Subcooling degree of coolant reactor core outlet
ii. Minimum deviation nucleate boiling value

$${q}_{D N B} = 3.154 \times 1 {0}^{6} \{ ( 2.022 - 6.238 \times 1 {0}^{- 8} p ) + ( 0.1722 - 1.43 \times 1 {0}^{- 8} p ) \times exp [ ( 18.177 - 5.987 \times 1 {0}^{- 7} p ) {x}_{e} ] \} [ ( 0.1484 - 1.596 x e + 0.1729 {x}_{e} \vert {x}_{e} \vert ) \times \frac{727.64 G}{1 {0}^{6}} + 1.037 ] ( 1.157 - 0.869 x e ) \times [ 0.2664 + 0.8357 exp ( - 124 D e ) ] \times [ 0.8258 + 0.341 \times 1 {0}^{6} ( {H}_{f} s - {H}_{f , i n} ) ]$$

(2) Thermal Economic Index
iii. Superheat degree of steam outlet

(3) Dynamic Response Characteristic Index
iv. Stationarity-overshoot (M_{P})

$$M p = ( \frac{c ( {t}_{p} ) - c ( ∞ )}{c ( ∞ )} ) \times 100 \%$$

where M_{P} is the overshoot, c(tₚ) is the peak value of the parameter, c(∞) is the steady-state value of the parameter, and tₚ is the time when the peak value is reached.

v. Speediness-adjustment time (tₛ)

|c(tₛ)−c(∞)|≤Δ,Δ=0.02c(∞)

where c(tₛ) is the steady-state value of the parameter ts, the steady-state value of the parameter ∞, and Δ is the criterion for judging whether the steady-state is reached.
vi. Steady-state performance-steady-state error (e)

$$e = \vert \frac{c ( ∞ ) - c ( set )}{c ( set )} \vert$$

where c(∞) is the steady-state value of the parameter and c(set) is the set value of the parameter.

S103: selecting one of the indexes such as safety, economic and dynamic characteristic indexes as the optimization target according to the actual operation requirements; the optimization variables are the constant operating parameters required by the control strategy in the design scheme; the feasible region is determined by the sensitivity analysis method of a single variable, a smaller value range is considered to reduce the calculation amount for the optimization variables with weak influence on the optimization goal.

S104: using the improved multi-population genetic algorithm to implement optimization calculation, setting the population number, individual number, variable dimension, generation gap value and maximum genetic algebra; the algorithm creates any discrete random population according to the parameter settings; calculating the objective function value of each initial population after chromosome coding, and each population performs evolutionary operations such as selection, crossover, mutation, etc. relatively independently, and the migration operator introduces the best individual into other populations every certain evolutionary algebra to replace the worst individual in the target population, so as to realize the information exchange of populations. When the genetic algebra reaches the maximum, the calculation is ended. In multi-population genetic algorithm, crossover probability and mutation probability determine the generation of new individuals. In order to speed up the search efficiency of the algorithm, individuals with high fitness should be kept as much as possible, while individuals with low fitness should be changed as much as possible. After introducing the adaptive strategy, the crossover operator pc and mutation operator pm change from fixed values to changes with the population fitness, and their calculation formulas are as follows:

$${p}_{ci} = \{ \begin{matrix}{p}_{c 0} + \frac{0.2 ( {f}_{max} - {f}_{i} )}{{f}_{max} - {f}_{avg}} , & {f}_{i} > {f}_{avg} \\ {p}_{c 0} , & {f}_{i} < {f}_{avg}\end{matrix}$$

where p_{c0} is the initial value of crossover operator, fₘₐₓ is the maximum fitness of individual, fᵢ is the current fitness of individual and f_{avg} is the average fitness of individuals;

$${p}_{m ι} = \{ \begin{matrix}{P}_{m 0} + \frac{0.015 ( {f}_{max} - {f}_{i} )}{{f}_{max} - {f}_{avg}} , & {f}_{i} > {f}_{avg} \\ {p}_{m 0} , & {f}_{i} < {f}_{avg}\end{matrix}$$

where pₘ₀ is the initial value of the crossover operator.

The operation control optimization scheme of the reactor system under the variable load condition may be obtained using the improved multi-population genetic algorithm calculation. The operation control optimization scheme solves the problem that the original algorithm is difficult to get the global optimal value in the later stage of calculation.

S105: verification and evaluation of the optimization scheme, as S2, obtaining the operating data of the main thermal parameters of the reactor system under the optimization scheme based on the simulation program, and calculating the operation safety index, thermal economic index and dynamic response characteristic index. The effectiveness of the optimization scheme can be verified by comparing with the calculation results of the design scheme. If the optimized requirement index is not significantly improved (change rate<10%) compared with the value under the design scheme, it is considered that the optimized calculation result does not meet the requirements, and return to the previous step to adjust the feasible region and then the optimized calculation is re-implemented; if the weak link in the initial scheme has been significantly improved after optimization (change rate>10%), and other response indexes still meet the operation control requirements, the calculation results are recognized and output. The obtained optimization result is the best parameter setting to meet the operation requirements under a given working condition.

### Embodiment 2

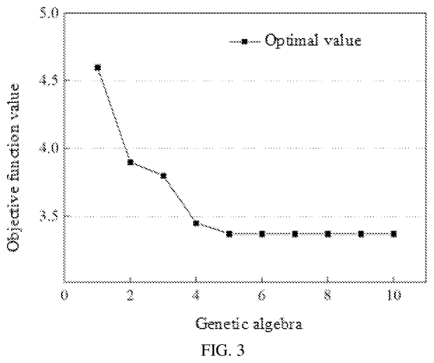

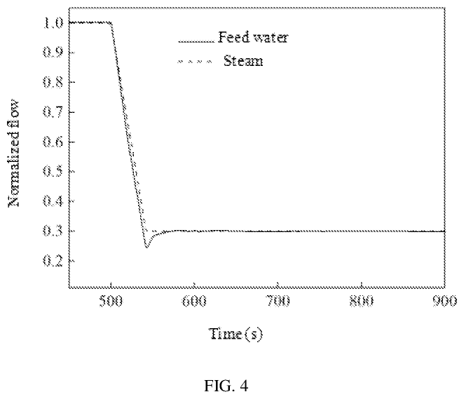

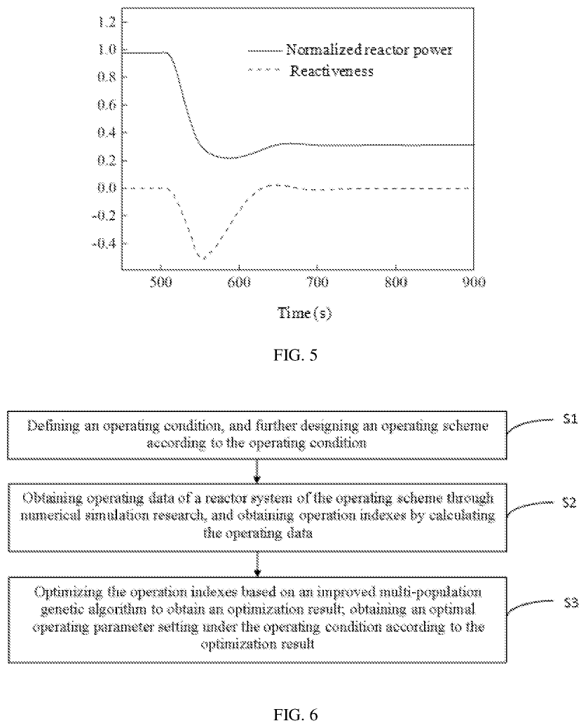

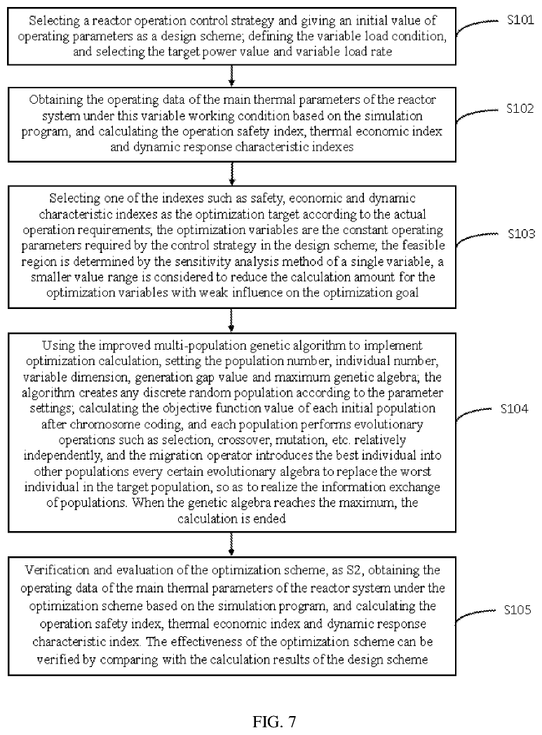

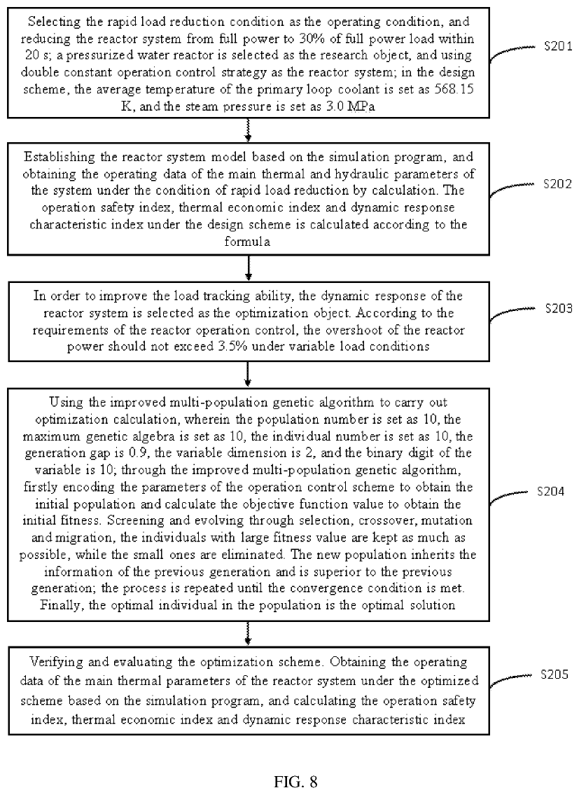

As shown in FIGS. 1-5, the reactor operation optimization method based on an improved multi-population genetic algorithm provided by the application includes the following steps:

S201: selecting the rapid load reduction condition as the operating condition, and reducing the reactor system from full power to 30% of full power load within 20 s; a pressurized water reactor is selected as the research object, and using double constant operation control strategy as the reactor system; in the design scheme, the average temperature of the primary loop coolant is set as 568.15 K, and the steam pressure is set as 3.0 MPa. The corresponding PID control principle is as follows:

$${n}_{0} = {k}_{1} G s + {k}_{2} [ ( {T}_{avg 0} - {T}_{a v g} ) + \frac{1}{τ} \int ( {T}_{avg 0} - {T}_{a v g} ) d t ]$$

where k₁ and k₂ represent proportional coefficients, τ represents integral time constant, Gₛ represents steam flow rate, T_{avg} represents average temperature of primary loop coolant, T_{avg0} represents set value of average temperature of primary loop coolant, and no represents demand power. The proportional coefficient k₁, k₂ and integral time constant τ are determined to be 0.012, 0.2 and 40 respectively according to the empirical trial calculation. Considering the influence of time lag, the delay time is 0.01 s.

$${G}_{fw}^{0} = {k}_{3} G s + {k}_{4} [ ( {p}_{2}^{0} - {p}_{2} ) + \frac{1}{τ} \int ( {p}_{2}^{0} - {p}_{2} ) d t ]$$

where k₃ and k₄ represent proportional coefficients, τ represents integral time constant, Gₛ represents steam flow rate, G_{fw}⁰ represents required feed water flow rate, p₂⁰ represents set value of steam pressure and p₂ represents steam pressure. According to the empirical trial calculation, the proportional coefficient k₃,k₄ and integral time constant τ are determined as 1.0, 0.000001 and 0.00002 respectively.

S202: establishing the reactor system model based on the simulation program, and obtaining the operating data of the main thermal and hydraulic parameters of the system under the condition of rapid load reduction by calculation. The operation safety index, thermal economic index and dynamic response characteristic index under the design scheme is calculated according to the formula. The results are shown in Table 1:

TABLE 1

| Evaluation index | Parameter | Value |
|---|---|---|
| Operation safety | Supercooling degree of the coolant reactor | 12K |
| | core outlet | |
| | Minimum deviation nucleate boiling value | 5.1 |
| Thermal economy | Superheat degree of steam outlet | 20K |
| Dynamic response | Reactor power overshoot | 4.81% |
| | Reactor power adjustment time | 180 s |
| | Reactor power steady-state error | 4.79% |
| | Average temperature of the primary loop | 2.05% |
| | overshoot | |
| | Peak value of steam pressure | 1.30 |
| | Feed water flow rate overshoot | 1.26% |
| | Feed water flow rate adjustment time | 56 s |
| | Feed water flow rate steady-state error | 0.14% |

S203: in order to improve the load tracking ability, the dynamic response of the reactor system is selected as the optimization object. According to the requirements of the reactor operation control, the overshoot of the reactor power should not exceed 3.5% under variable load conditions. However, this value is quite different from the required value in the design scheme, so the overshoot of the reactor power is selected as the optimization objective; the optimization variables are the average temperature and steam pressure of the primary loop coolant required by the double constant operation control strategy. According to the sensitivity analysis, the influence of the average temperature of the primary loop coolant on the power overshoot of the reactor is weaker than that of the steam pressure, so the range of the average temperature of the primary loop coolant is determined to be [568.15 K, 578.15 K], and the range of the steam pressure is determined to be [3.0 MPa, 3.5 MPa].

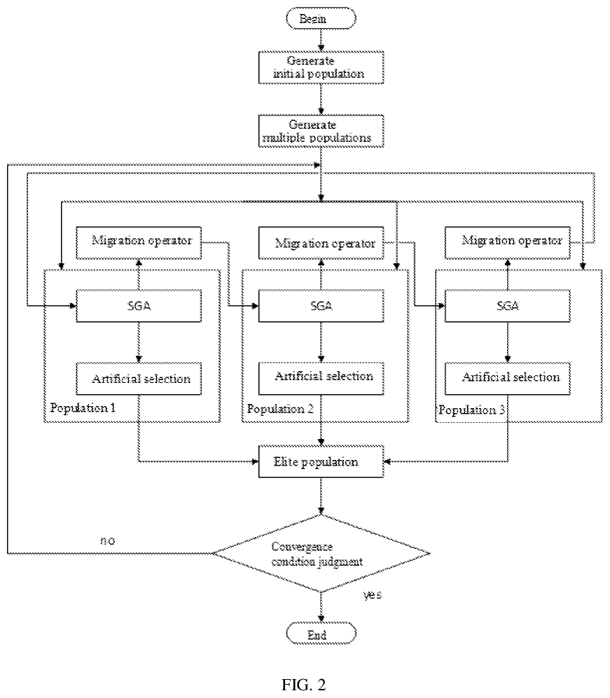

S204: using the improved multi-population genetic algorithm to carry out optimization calculation, wherein the population number is set as 10, the maximum genetic algebra is set as 10, the individual number is set as 10, the generation gap is 0.9, the variable dimension is 2, and the binary digit of the variable is 10; through the improved multi-population genetic algorithm, firstly encoding the parameters of the operation control scheme to obtain the initial population and calculate the objective function value to obtain the initial fitness. Screening and evolving through selection, crossover, mutation and migration, the individuals with large fitness value are kept as much as possible, while the small ones are eliminated. The new population inherits the information of the previous generation and is superior to the previous generation; the process is repeated until the convergence condition is met. Finally, the optimal individual in the population is the optimal solution. See FIG. 2 for its calculation process. Through optimization calculation, the average temperature of the primary loop coolant is 572.15 K and the steam pressure is 3.41 MPa.

S205: verifying and evaluating the optimization scheme. Obtaining the operating data of the main thermal parameters of the reactor system under the optimized scheme based on the simulation program, and calculating the operation safety index, thermal economic index and dynamic response characteristic index. Compared with the calculation results of the design scheme, as shown in Table 2. It can be seen that the overshoot of the reactor power is obviously reduced after optimization, which meets the control operation requirements of less than or equal to 3.5%, and other indexes are not deteriorated. Therefore, it is considered that the optimization calculation results meet the requirements, and the optimization results are output as the best operating parameter setting of the selected reactor operation control scheme under the variable load condition.

TABLE 2

| | | Optimized | Original |
|---|---|---|---|
| Operating parameters | Evaluation index | scheme | scheme |
| Reactor power | Overshoot | 3.27% | 4.81% |
| | Adjustment time | 181 s | 180 s |
| | Steady-state error | 3.93% | 4.79% |
| Average temperature | Overshoot | 2.02% | 2.05% |
| of the primary loop | | | |
| Vapor pressure | Normalized peak | 1.31 | 1.30 |
| | value | | |
| Feed water flow rate | Overshoot | 0.97% | 1.26% |
| | Adjustment time | 50 s | 56 s |
| | Steady-state error | 0.09% | 0.14% |

The crossover probability and mutation probability in the later evolution period are increased by introducing the adaptive strategy into the crossover operator and mutation operator in the algorithm, and the local optimum is avoided. The probability of the improved adaptive crossover operator and mutation operator changes with the population fitness, thus further balancing the global search and local search capabilities of the algorithm.

The application improves the crossover operator and mutation operator in the multi-population genetic algorithm based on the adaptive strategy, and applies in the optimization of reactor operation characteristics. Based on the actual operation control requirements, on the premise of not changing the operation control strategy, the optimal combination of parameter settings in the operation control scheme is discussed, which provides support for improving reactor operation characteristics, and has a broad application prospect in practical projects.

The above-mentioned embodiments only describe the preferred modes of the application, but do not limit the scope of the application. On the premise of not departing from the design spirit of the application, all kinds of modifications and improvements made by ordinary technicians in the field to the technical scheme of the application shall fall within the scope of protection determined by the claims of the application.

What is claimed is:

1. A reactor operation optimization method based on an improved multi-population genetic algorithm, comprising:
S1: defining an operating condition, and further designing an operating scheme according to the operating condition;
S2: obtaining operating data of a reactor system of the operating scheme through numerical simulation research, and obtaining operation indexes by calculating the operating data; and
S3: optimizing the operation indexes based on an improved multi-population genetic algorithm to obtain an optimization result; obtaining an optimal operating parameter setting under the operating condition according to the optimization result.

2. The reactor operation optimization method according to claim 1, wherein,
the operation indexes at least comprise an operation safety index and a thermal economic index;
the operation safety index is obtained by calculating a supercooling degree of a coolant reactor core outlet and a minimum deviation nucleate boiling value; and
the thermal economic index is obtained by calculating a superheat degree of a steam outlet.

3. The reactor operation optimization method according to claim 1, wherein,
the operation indexes comprise dynamic response indexes;
the dynamic response indexes at least comprise a stationarity index, a rapidity index and a steady-state performance index;
the stationarity index is obtained by calculating a overshoot;
the rapidity index is obtained by calculating an adjustment time; and
the steady-state performance index is obtained by calculating a steady-state error.

4. The reactor operation optimization method according to claim 1, before optimizing the operation indexes based on the improved multi-population genetic algorithm, further comprising:
determining the operation indexes to be optimized according to the actual demand; determining optimization variables and feasible regions, and carrying out the optimization calculation of the operation indexes to be optimized by using the improved multi-population genetic algorithm.

5. The reactor operation optimization method according to claim 4, wherein,
the optimization variables are constant operating parameters required by a control strategy in the operating scheme; and
the feasible regions are determined by a sensitivity analysis method of a single variable.

6. The reactor operation optimization method according to claim 4, wherein,
the process of carrying out the optimization calculation of the operation indexes to be optimized by using the improved multi-population genetic algorithm comprises,
providing operating parameters, wherein the multi-population genetic algorithm creates discrete random population according to parameter settings of the operating parameters, calculates the objective function value of initial population after chromosome coding, and performs evolutionary operations on the initial population; a migration operator introduces a best individual into other populations every definite evolutionary algebra to replace a worst individual in a target population and realize the information exchange of the target population, and ends the calculation when a genetic algebra reaches a maximum value.

7. The reactor operation optimization method according to claim 6, wherein,
the operating parameters at least comprise a population number, an individual number, a variable dimension, a generation gap value and maximum genetic algebra.

8. The reactor operation optimization method according to claim 6, wherein,
the evolutionary operations on the initial population at least comprise a selection operation, a crossover operation and a mutation operation; and
the crossover operation and mutation operation are based on adaptive strategies, and the crossover operator and mutation operator change from fixed values to changes with the fitness of the population.

9. The reactor operation optimization method according to claim 6, wherein obtaining the optimal operating parameter setting under the operating condition comprises:
comparing the operation result of the optimized scheme with the operation result of the designed operating scheme, and if the requirements are not met, returning to adjust the feasible region and recalculating; if the requirements are met, obtaining the optimal operating parameter setting under the operating condition based on the operation result of the optimization scheme.
